(19) United States
(12) Patent Application Publication
(10) Pub. No.: US 2016/0179680 A1
(43) Pub. Date: Jun. 23, 2016

(54) SYSTEMS AND METHODS FOR INTEGRATED ROTATION OF PROCESSOR CORES

(71) Applicant: Dell Products L.P., Round Rock, TX (US)

(72) Inventors: Thomas Alexander Shows, Cedar Park, TX (US); Travis C. North, Cedar Park, TX (US)

(21) Appl. No.: 14/575,665

(22) Filed: Dec. 18, 2014

(51) Int. Cl. G06F 12/08; G06F 9/455; G06F 9/50

(52) U.S. Cl. CPC G06F 12/0864; G06F 9/5016; G06F 9/5083; G06F 9/45558; G06F 2212/6032; G06F 2009/4557

(57) ABSTRACT

In accordance with embodiments of the present disclosure, a processor may include a plurality of cores integrated within an integrated circuit package and a thermal rotation management module communicatively coupled to each of the plurality of cores and integrated within the integrated circuit package. The thermal rotation management module may be configured to, responsive to a temperature of a first core of the plurality of cores exceeding a threshold temperature, identify a second core of the plurality of cores for relocating a workload executing on the first core and relocate the workload executing on the first core to the second core.

### TECHNICAL FIELD

The present disclosure relates in general to information handling systems, and more particularly to thermal management in a multi-core processor.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

To maximize processing throughput, an operating system executing on an information handling system may be capable of scheduling threads among a plurality of cores of a multi-core processor. While such scheduling may increase cache hit rates and/or other performance parameters, it may also have a tendency to cause long durations of execution upon a particular core, which may in turn cause heat increases at or near such core, which may decrease performance, as overheated cores may throttle performance in order to reduce temperature.

Further complicating matters, sizes of transistors used in processors continue to shrink with each new generation. Accordingly, heat generated by thread execution of a core may further be exacerbated as the heat is generated from a smaller area of the processor die. This has the tendency to increase the thermal resistance of processors which each new generation, making it more and more difficult to transfer heat generated by a core to the air using heat pipes, heat fins, heat sinks, or other thermal transfer techniques.

### SUMMARY

In accordance with the teachings of the present disclosure, the disadvantages and problems associated with thermal control in a multi-core processor may be substantially reduced or eliminated.

In accordance with embodiments of the present disclosure, a processor may include a plurality of cores integrated within an integrated circuit package and a thermal rotation management module communicatively coupled to each of the plurality of cores and integrated within the integrated circuit package. The thermal rotation management module may be configured to, responsive to a temperature of a first core of the plurality of cores exceeding a threshold temperature, identify a second core of the plurality of cores for relocating a workload executing on the first core and relocate the workload executing on the first core to the second core.

In accordance with these and other embodiments of the present disclosure, a method may include, responsive to a temperature of a first core of a plurality of cores integrated within an integrated circuit package exceeding a threshold temperature, identifying a second core of the plurality of cores for relocating a workload executing on the first core and relocating the workload executing on the first core to the second core.

In accordance with these and other embodiments of the present disclosure, an information handling system may include a processor and a memory communicatively coupled to the processor. The processor may include a plurality of cores integrated within an integrated circuit package and a thermal rotation management module communicatively coupled to each of the plurality of cores and integrated within the integrated circuit package. The thermal rotation management module may configured to responsive to a temperature of a first core of the plurality of cores exceeding a threshold temperature, identify a second core of the plurality of cores for relocating a workload executing on the first core, and relocate the workload executing on the first core to the second core.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with embodiments of the present disclosure;

FIG. 2 illustrates a block diagram of an example processor, in accordance with embodiments of the present disclosure; and

FIG. 3 illustrates a flow chart of an example method for thermal control of a multi-core processor, in accordance with embodiments of the present disclosure.

### DETAILED DESCRIPTION

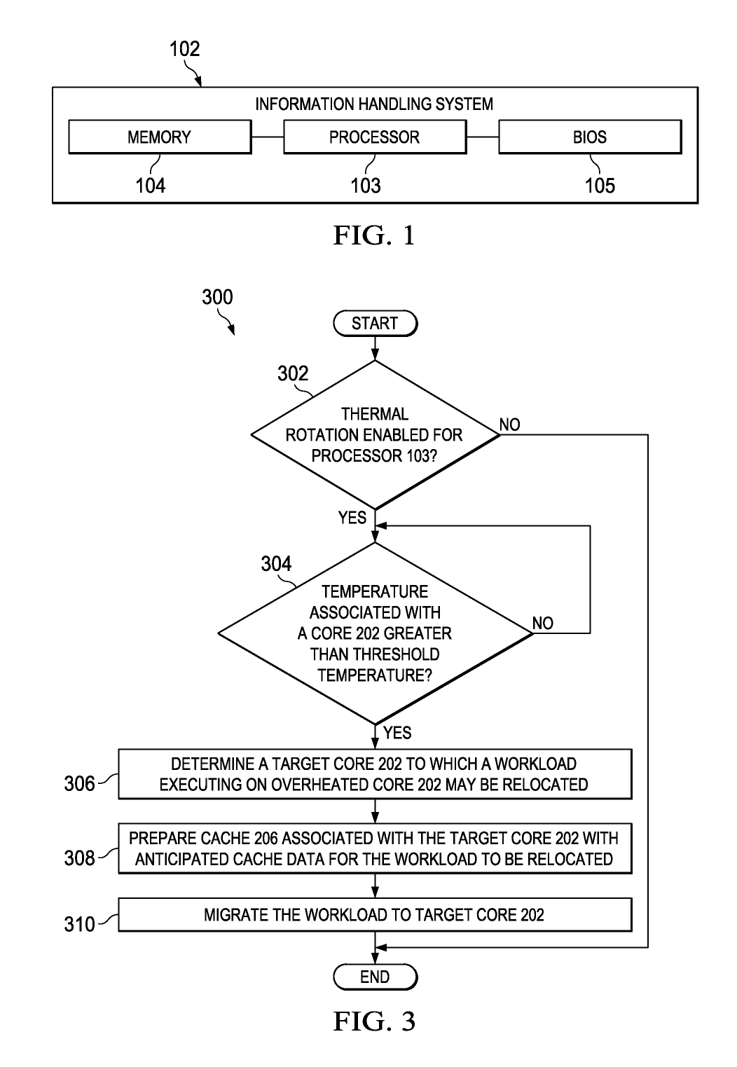

Preferred embodiments and their advantages are best understood by reference to FIGS. 1 through 3, wherein like numbers are used to indicate like and corresponding parts.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a PDA, a consumer electronic device, a network storage device, or any other suitable device and may vary in size, shape, performance, functionality, and price. The information handling system may include memory, one or more processing resources such as a central processing unit (CPU) or hardware or software control logic. Additional components of the information handling system may include one or more storage devices, one or more communications ports for communicating with external devices as well as various input and output (I/O) devices, such as a keyboard, a mouse, and a video display. The information handling system may also include one or more buses operable to transmit communication between the various hardware components.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read- only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

For the purposes of this disclosure, information handling resources may broadly refer to any component system, device or apparatus of an information handling system, including without limitation processors, buses, memories, I/O devices and/or interfaces, storage resources, network interfaces, motherboards, integrated circuit packages; electro-mechanical devices (e.g., air movers), displays, and power supplies.

FIG. 1 illustrates a block diagram of an example information handling system 102, in accordance with the present disclosure. In some embodiments, information handling system 102 may comprise a server chassis configured to house a plurality of servers or “blades.” In other embodiments, information handling system 102 may comprise a personal computer (e.g., a desktop computer, laptop computer, mobile computer, and/or notebook computer). In yet other embodiments, information handling system 102 may comprise a mobile device sized and shaped to be readily transportable on the person of a user (e.g., a mobile phone, tablet, personal digital assistant, digital music player, etc.). In yet other embodiments, information handling system 102 may comprise a storage enclosure configured to house a plurality of physical disk drives and/or other computer-readable media for storing data. As shown in FIG. 1, information handling system 102 may comprise a processor 103, a memory 104, and a BIOS 105.

Processor 103 may comprise any system, device, or apparatus operable to interpret and/or execute program instructions and/or process data, and may include, without limitation a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104 and/or another component of information handling system 102. In these and other embodiments, processor 103 may comprise a multi-core processor, as described in greater detail below. Memory 104 may be communicatively coupled to processor 103 and may comprise any system, device, or apparatus operable to retain program instructions or data for a period of time. Memory 104 may comprise random access memory (RAM), electrically erasable programmable read-only memory (EEPROM), a PCMCIA card, flash memory, magnetic storage, opto-magnetic storage, or any suitable selection and/or array of volatile or non-volatile memory that retains data after power to information handling system 102 is turned off.

A BIOS 105 may include any system, device, or apparatus configured to identify, test, and/or initialize information handling resources of information handling system 102, and/or initialize interoperation of information handling system 102 with other information handling systems. “BIOS” may broadly refer to any system, device, or apparatus configured to perform such functionality, including without limitation, a Unified Extensible Firmware Interface (UEFI). In some embodiments, BIOS 105 may be implemented as a program of instructions that may be read by and executed on processor 103 to carry out the functionality of BIOS 105. In these and other embodiments, BIOS 105 may comprise boot firmware configured to be the first code executed by processor 103 when information handling system 102 is booted and/or powered on. As part of its initialization functionality, code for BIOS 105 may be configured to set components of information handling system 102 into a known state, so that one or more applications (e.g., an operating system or other application programs) stored on compatible media (e.g., disk drives) may be executed by processor 103 and given control of information handling system 102. In some embodiments, BIOS 105 may also be configured to store user settings for selectively enabling or disabling thermal control of processor 103 using integrated thermal rotation of processor cores, as described in greater detail below.

In addition to processor 103, memory 104, and BIOS 105, information handling system 102 may include one or more other information handling resources.

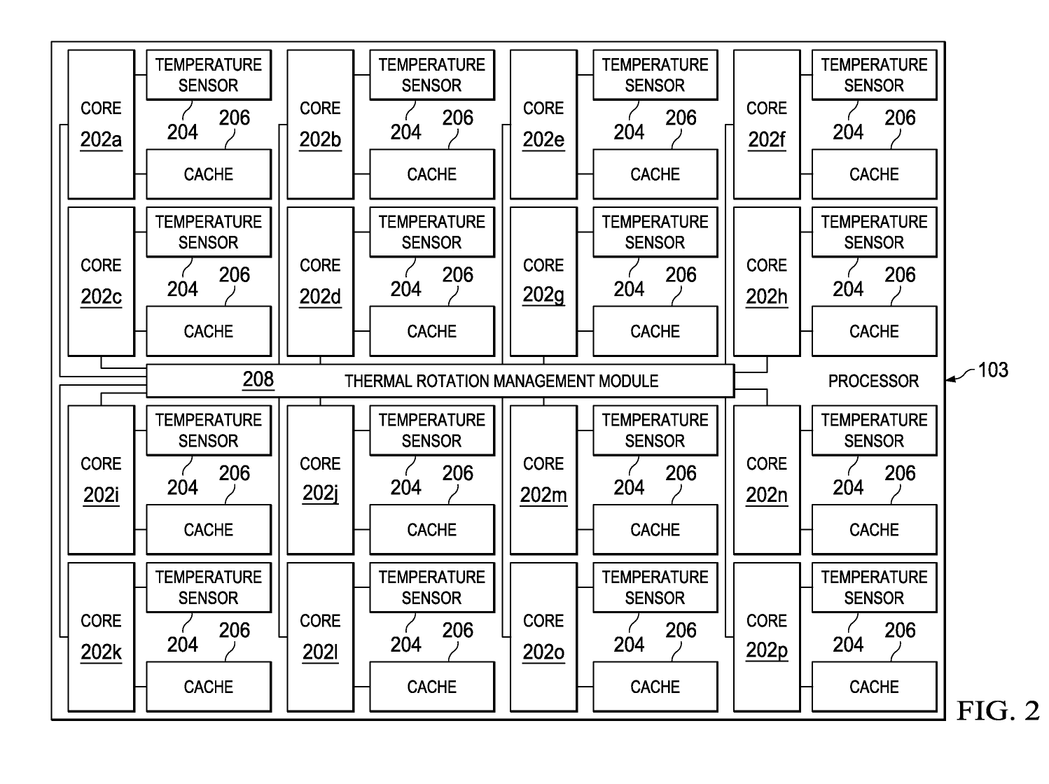

FIG. 2 illustrates a block diagram of an example multi-core processor 103, in accordance with embodiments of the present disclosure. As shown in FIG. 2, processor 103 may comprise a plurality of cores 202 (e.g., cores 202a-202p), each core 202 integrated or formed on the same integrated circuit die or onto multiple dies in a single chip package. Each core 202 may be communicatively coupled to a thermal rotation management module 208, also formed on the same integrated circuit die as cores 202 or onto a die in a single chip package comprising cores 202.

Each core 202 may comprise an independent actual central processing unit to read and execute program instructions, and cores 202 may operate in parallel to execute multiple instructions simultaneously on processor 103. As described above, at the direction of a thread scheduler, each of one or more threads of executable instructions may be scheduled for execution on a particular core 202.

As shown in FIG. 2, each core 202 may be coupled to an associated temperature sensor 204 and an associated cache 206. A temperature sensor 204 may be any system, device, or apparatus (e.g., a thermometer, thermistor, etc.) configured to communicate a signal to its associated core 202 indicative of a temperature within such core 202.

A cache 206 is a memory used by a core 202 to reduce the average time to access data from main memory 104. A cache 206 may be a smaller, faster memory than memory 104 and may store copies of frequently-used data and instructions from memory 104. In some embodiments, a cache 206 may comprise an independent data cache and instruction cache. In these and other embodiments, a cache may be organized in a hierarchy of multiple cache levels (e.g., level 1, level 2, etc.). In these or other embodiments, all or part of cache 206 associated with one core 202 may be shared with another core 202.

A thermal rotation management module 208 may include any system, device, or apparatus for monitoring when a workload may produce high temperatures in a core 202, and in advance of that condition, reschedule that workload onto a different core 202 which is much cooler. In order to reschedule the workload, thermal rotation management module 208 may be configured to, ahead of such rescheduling, prepare or “prime” a cache 206 associated with the core 202 to which the workload is to be rescheduled, in order to reduce or eliminate any performance penalty associated with the migration of the workload from core to core. In addition, because thermal rotation management module 208 is local to processor 103, it may be configured to group multiple cores 202 together and expose them to an operating system executing on information handling system 102 as a single logical core. For example, in the sixteen-core embodiment depicted in FIG. 2, thermal rotation management module 208 may, with core rotation enabled, report as having only eight logical cores. This would then provide, internal to processor 103, a rotation mechanism whereby a thread could be migrated back and forth between two physical cores 202 making up a logical core, independent of operating system or upper-level software interaction.

In some embodiments, a logical core may include more than two physical cores 202. For example, in the sixteen-core embodiment depicted in FIG. 2, thermal rotation management module 208 may, with core rotation enabled, report as having only four logical cores, each logical core comprising four physical cores 202. In such embodiments, the level of core redundancy may be selectable by a user via configuration options of BIOS 105.

In these and other embodiments, for situations in which full redundancy of all physical cores 202 is unnecessary or not desired, a hybrid mode may be available (and configurable via BIOS 105) whereby some of physical cores 202 may be devoted to core rotation while other physical cores 202 would not. For example, in one example mode of operation, eight physical cores 202a-204d and 202m-202p may be devoted to core rotation (e.g., two physical cores for each of four logical cores) while eight physical cores 202e-202l would not participate in core rotation, with each of such physical cores 202 being reported as a logical core.

By intelligently rotating core workloads throughout processor 103, processor 103 may experience dramatic reductions in package temperature as compared to approaches which do not use thermal rotation, as thermal rotation may effectively add as a heat spreader, allowing regions of processor 103 to heat up and cool down independently of one another, assuming rotation is performed between cores with sufficient distance from each other on processor 103.

For ease of exposition, FIG. 2 depicts sixteen cores 202 within processor 103. However, it is understood that processor 103 may comprise any suitable number of cores 202. Also, in addition to cores 202, temperature sensors 204, caches 206, and thermal rotation management module 208, processor 103 may include one or more other components.

FIG. 3 illustrates a flow chart of an example method 300 for thermal control of a multi-core processor (e.g., processor 103), in accordance with embodiments of the present disclosure. According to one or more embodiments, method 300 may begin at step 302. As noted above, teachings of the present disclosure may be implemented in a variety of configurations of information handling system 102. As such, the preferred initialization point for method 300 and the order of the steps comprising method 300 may depend on the implementation chosen.

At step 302, thermal rotation management module 208 may determine if thermal rotation is enabled for processor 103. For example, in some embodiments, thermal rotation management module 208 may determine if a configuration option of BIOS 105 indicates that thermal rotation is enabled. If thermal rotation is enabled for processor 103, method 300 may proceed to step 304. Otherwise, method 300 may end, and traditional thermal management and/or thread scheduling approaches may be used.

At step 304, responsive to thermal rotation being enabled for processor 103, thermal rotation management module 208 may determine if a temperature associated with a core 202 within processor 103 has exceeded a threshold temperature. In some embodiments, an individual core 202 may determine if its associated temperature sensor 204 is above the threshold temperature, and communicate an indication to thermal rotation management module 208 that its temperature has exceeded the threshold. In other embodiments, an individual core 202 may communicate an indication of a temperature reported by its associated temperature sensor 204 to thermal rotation management module 208, and thermal rotation management module 208 may in turn compare temperatures reported from the multiple cores 202 against the threshold temperature. In response to a temperature associated with a core 202 exceeding the threshold temperature, method 300 may proceed to step 306.

Otherwise, method 300 may remain at step 304 until a temperature associated with a core 202 exceeds the threshold temperature.

At step 306, responsive to a temperature associated with a core 202 exceeding a threshold temperature, thermal rotation management module 208 may determine a target core 202 to which a workload executing on the overheated core 202 may be relocated. In some embodiments, cores 202 of processor 103 may each be assigned to a particular logical core. For example, in an embodiment in which each logical core has two physical cores 202, each core 202 may be paired with another core 202. To maximize the benefit of core rotation, paired cores 202 may be located in another portion of processor 103. As a specific example, cores 202a, 202b, 202c, and 204d may be paired with cores 202m, 202n, 202o, and 202p, respectively, while cores 202e, 202f, 202g, and 204h may be paired with cores 202i, 202j, 202k, and 202l, respectively. In such embodiments, when the temperature of one core 202 of a pair has exceeded the threshold temperature, thermal rotation management module 208 may identify or select the other core 202 of the pair as the target core for relocating the workload.

As another example, in an embodiment in which each logical core has four physical cores 202, cores 202a, 202e, 202i, and 202m may be members of one logical core, cores 202b, 202f, 202j, and 202n may be members of another logical core, cores 202c, 202g, 202k, and 202o may be members of another logical core, and cores 202d, 202h, 202l, and 202p may be members of another logical core. In such embodiments, when the temperature of one core 202 of a logical core has exceeded the threshold temperature, thermal rotation management module 208 may identify or select a target core from the remaining cores in any suitable manner. For example, a round robin approach may be used wherein thermal rotation management module 208 rotates execution among cores 202 of a logical core in a defined, hard-coded order (e.g., core 202a to core 202e to core 202i to core 202m and back to core 202a). As another example, an approach may be used wherein the target core 202 selected is the one within the logical core having the lowest temperature. As a further example, the target core 202 may be selected based on cache content of the workload to be relocated. In some embodiments, a combination of two or more of the foregoing factors, or other factors, may be considered to identify a target core 202.

At step 308, thermal rotation management module 208 may prepare a cache 206 associated with the target core 202 with anticipated cache data for the workload to be relocated, in order to reduce or eliminate any latency associated with the transfer of the workload. The anticipated cache data may be based on data in a cache 206 associated with the overheated core, branch prediction logic of processor 103, or any other suitable approach.

At step 310, after preparation of the cache 206 associated with the target core 202, thermal rotation management module 208 may migrate the workload to the target core 202 in a manner transparent to software executing on information handling system 102. After completion of step 310, method 300 may end.

Although FIG. 3 discloses a particular number of steps to be taken with respect to method 300, method 300 may be executed with greater or fewer steps than those depicted in FIG. 3. In addition, although FIG. 3 discloses a certain order of steps to be taken with respect to method 300, the steps comprising method 300 may be completed in any suitable order.

Method 300 may be implemented using information handling system 102 or any other system operable to implement method 300. In certain embodiments, method 300 may be implemented partially or fully in software and/or firmware embodied in computer-readable media and executable on a processor or controller of information handling system 102.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

What is claimed is:

1. A processor comprising:
a plurality of cores integrated within an integrated circuit package; and
a thermal rotation management module communicatively coupled to each of the plurality of cores and integrated within the integrated circuit package, the thermal rotation management module configured to:
responsive to a temperature of a first core of the plurality of cores exceeding a threshold temperature, identify a second core of the plurality of cores for relocating a workload executing on the first core; and
relocate the workload executing on the first core to the second core.

2. The processor of claim 1, wherein the plurality of cores and the thermal rotation management module are formed on the same integrated circuit die.

3. The processor of claim 1, wherein the thermal rotation management module is further configured to, before relocation of the workload to the second core, prepare a cache associated with the second core with anticipated cache data for the workload.

4. The processor of claim 3, wherein the anticipated cache data is based on at least one of data present in a cache associated with the first core and branch prediction associated with the workload.

5. The processor of claim 3, wherein the second core is identified based on the anticipated cache data.

6. The processor of claim 1, wherein the first core and the second core are members of a logical core.

7. The processor of claim 1, wherein the second core is identified based on a temperature associated with the second core and one or more temperatures respectively associated with one or more cores of the plurality of cores other than the first core.

8. A method comprising:
responsive to a temperature of a first core of a plurality of cores integrated within an integrated circuit package exceeding a threshold temperature, identifying a second core of the plurality of cores for relocating a workload executing on the first core; and
relocating the workload executing on the first core to the second core.

9. The method of claim 8, further comprising, before relocation of the workload to the second core, preparing a cache associated with the second core with anticipated cache data for the workload.

10. The method of claim 9, wherein the anticipated cache data is based on at least one of data present in a cache associated with the first core and branch prediction associated with the workload.

11. The method of claim 9, wherein the second core is identified based on the anticipated cache data.

12. The method of claim 8, wherein the first core and the second core are members of a logical core.

13. The method of claim 8, wherein the second core is identified based on a temperature associated with the second core and one or more temperatures respectively associated with one or more cores of the plurality of cores other than the first core.

14. An information handling system comprising:
a processor comprising:
a plurality of cores integrated within an integrated circuit package; and
a thermal rotation management module communicatively coupled to each of the plurality of cores and integrated within the integrated circuit package, the thermal rotation management module configured to:
responsive to a temperature of a first core of the plurality of cores exceeding a threshold temperature, identify a second core of the plurality of cores for relocating a workload executing on the first core; and
relocate the workload executing on the first core to the second core; and
a memory communicatively coupled to the processor.

15. The information handling system of claim 14, wherein the plurality of cores and the thermal rotation management module are formed on the same integrated circuit die.

16. The information handling system of claim 14, wherein the thermal rotation management module is further configured to, before relocation of the workload to the second core, prepare a cache associated with the second core with anticipated cache data for the workload.

17. The information handling system of claim 16, wherein the anticipated cache data is based on at least one of data present in a cache associated with the first core and branch prediction associated with the workload.

18. The information handling system of claim 16, wherein the second core is identified based on the anticipated cache data.

19. The information handling system of claim 14, wherein the first core and the second core are members of a logical core.

20. The information handling system of claim 14, wherein the second core is identified based on a temperature associated with the second core and one or more temperatures respectively associated with one or more cores of the plurality of cores other than the first core.
